(19) United States
(12) Patent Application Publication
(10) Pub. No.: US 2014/0286274 A1
(43) Pub. Date: Sep. 25, 2014

(54) METHOD AND CORRESPONDING APPARATUS FOR UPLINK CONTROL CHANNEL POWER CONTROL

(71) Applicants: Jin Liu, Shanghai (CN); Xudong Zhu, Shanghai (CN); Yubo Yang, Shanghai (CN); Peng Shang, Shanghai (CN)

(72) Inventors: Jin Liu, Shanghai (CN); Xudong Zhu, Shanghai (CN); Yubo Yang, Shanghai (CN); Peng Shang, Shanghai (CN)

(73) Assignee: ALCATEL LUCENT, Paris (FR)

(21) Appl. No.: 14/345,742

(22) PCT Filed: Sep. 21, 2012
(86) PCT No.: PCT/IB2012/002175

§ 371 Date: Mar. 19, 2014

(30) Foreign Application Priority Data
Sep. 30, 2011 (CN) 201110296380.4

(51) Int. Cl. H04W 52/38; H04W 24/02; H04L 5/00

(52) U.S. Cl. CPC H04W 52/38; H04L 5/0053; H04W 24/02
USPC 370/329

(57) ABSTRACT

Embodiments of the present invention provide a method for power control of a uplink control channel in a coordinated multi-point transmission system. The method comprises: performing the uplink control channel power control based on measured pathloss from a single reception point to the user equipment in a scenario of single-point reception of the uplink control channel; performing the uplink control channel power control by reducing uplink control channel transmission power of the user equipment to thereby reduce inter-cell interference incurred by multi-reception-point reception combining gain in a scenario of multi-point reception of the uplink control channel. Embodiments of the present invention further provide an apparatus for power control of a uplink control channel in a coordinated multi-point transmission system and a corresponding base station.

### FIELD OF THE INVENTION

The present application generally relates to wireless communications technology, and more specifically, to methods for uplink control channel power control and corresponding apparatuses.

### BACKGROUND OF THE INVENTION

Power control of a physical uplink control channel is defined in the literature 3GPP TS36.213 V10.1.0 entitled “LTE: Evolved Universal Terrestrial Radio Access (E-UTRA) Physical layer procedures (Release 10)” in March 2011, which is incorporated here by reference. If the serving cell c is a primary cell, the transmission power of user equipment for physical uplink control channel transmission in the ith subframe is provided in the following equation:

$${P}_{PUCCH} ( i ) = min \{ \begin{matrix}{P}_{CMAX , c} ( i ) , \\ \begin{matrix}{P}_{0 \_PUCCH} + {PL}_{c} + h ( {n}_{CQI} , {n}_{HARQ} , {n}_{SR} ) + \\ {Δ}_{F\_PUCCH} ( F ) + {Δ}_{T \times D} ( {F}^{′} ) + g ( i )\end{matrix}\end{matrix} \} [ dBm ]$$

wherein,

P_{CMAX,c} (i) denotes the UE transmission power configured for the serving cell c in the ith subframe;

P₀_{_{—}}_{PUCCh} is the target received power and reflects an average interference level; P₀_{_{—}}_{PUCCh} is composed of a sum of a cell-specific component

$$\text{?}$$

$$\text{?} \text{indicates text missing or illegible when filed}$$

and a UE-specific component

$$\text{?}$$

$$\text{?} \text{indicates text missing or illegible when filed}$$

as provided through a higher layer signaling;

P_{c} is a downlink pathloss estimate for serving cell c, the pathloss estimate PL_{c} is measured at the user equipment side based on an issued reference signal;

h(n_{CQI},n_{HARQ},n_{SR}) and Δ_{F}_{_{—}}_{PUCCH}(F) are PUCCH format (content) dependent parameters;

Δ_{TxD}(F′) corresponds to the number of antenna ports for PUCCH transmission; and

g(i) is a closed-loop power control component.

Although PUCCH power control has been enhanced in the prior art to consider carrier aggregation and multiple antenna transmission, the PUCCH power control was merely designed for a single-cell transmission. In an uplink multi-point coordination system, it is allowed to receive PUCCH at a single reception point, or to receive PUCCH at multiple reception points through multi-point coordination. Thus, in order to optimize the uplink multi-point coordination in different scenarios, it is desirable to provide a PUCCH power control solution for the coordinated multi-point transmission system.

### SUMMARY OF THE INVENTION

In order to solve the technical problems existing in the prior art, the present invention provides a power control solution for an uplink control channel in a a coordinated multi-point transmission system, which considers different open-loop power control mechanisms for single-point reception of the uplink control channel and multi-point reception of the uplink control channel, so as to optimize the power control of a uplink control channel when performing multi-point coordination in different scenarios.

According to one aspect of the present invention, there is provided a method for power control of a uplink control channel in a coordinated multi-point transmission system. The method comprises: in a scenario of receiving the uplink control channel at a single reception point, performing the power control of the uplink control channel based on a measured passloss from the single reception point to a user equipment; in a scenario of receiving the uplink control channel at multiple reception points, performing the power control of the uplink control channel by reducing uplink control channel transmission power of the user equipment to thereby reduce inter-cell interference incurred by multi-point reception coherence combining gain.

According to another aspect of the present invention, there is provided an apparatus for power control of a uplink control channel in a coordinated multi-point transmission system. The apparatus comprises: a module configured to, in a scenario of receiving the uplink control channel in a single reception point, perform the power control of the uplink control channel based on a measured passloss from the single reception point to a user equipment; a module configured to, in a scenario of receiving the uplink control channel at multiple reception points, perform the power control of the uplink control channel by reducing user equipment uplink control channel transmission power to thereby reduce inter-cell interference incurred by multi-point reception coherence combining gain.

According to another aspect of the present invention, there is provided a base station device comprising the apparatus for power control of a uplink control channel in a coordinated multi-point transmission system according to the embodiments of the present invention.

### BRIEF DESCRIPTION OF THE SEVERAL VIEWS OF THE DRAWINGS

In order to more thoroughly understand the exemplary embodiments of the present invention, the following depiction is made with reference to the accompanying drawings, wherein:

FIG. 1 shows a flowchart of a method for power control of a uplink control channel in a multi-point coordination system according to one exemplary embodiment of the present invention;

FIG. 2 shows a block diagram of an apparatus for power control of a uplink control channel in a multi-point coordination system according to one exemplary embodiment of the present invention.

### DETAILED DESCRIPTION OF THE INVENTION

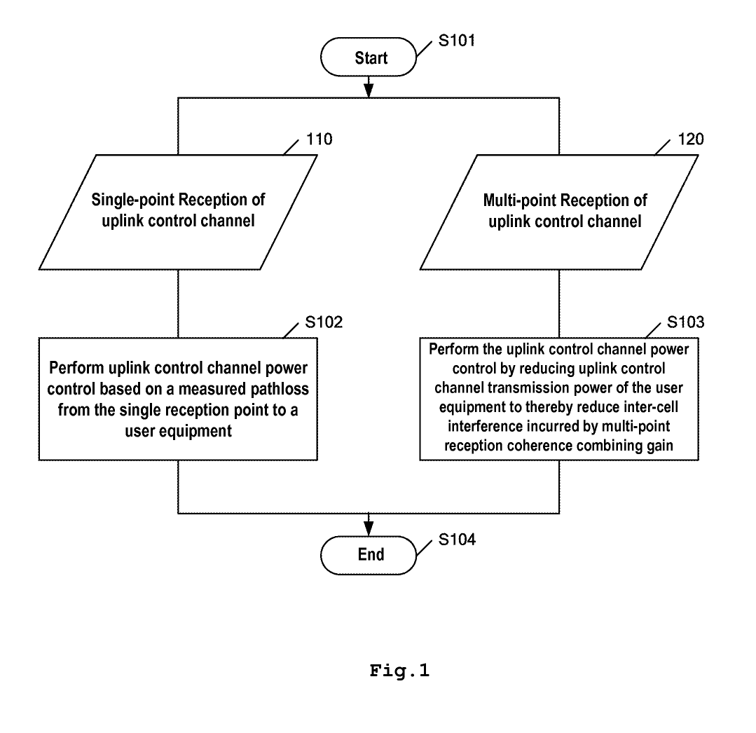

FIG. 1 shows a flowchart of a method for power control of a uplink control channel in a multi-point coordination system according to one exemplary embodiment of the present invention.

As shown in FIG. 1, in step S101, the method flow starts.

Although the physical uplink sharing channel (PUSCH) is jointly received at multiple points in a multi-point coordination system, the physical uplink control channel (PUCCH) in the system can be received at a single reception point or multiple reception points, i.e., the PUCCH power control may be associated with not only single-point reception but also multi-point reception. Condition blocks 110 and 120 in FIG. 1 illustrate the two scenarios, respectively.

In a scenario of single-point reception of the uplink control channel, in step S102, the uplink control channel power control is performed based on a measured pathloss from the single reception point to the user equipment.

As mentioned in the background, the transmission power of user equipment for physical uplink control channel transmission is dependent on the downlink pathloss estimate for the serving cell c. In the scenario of single-reception of physical uplink control channel, power control should be performed for the single reception point; thus, it is required that the user equipment estimate the downlink pathloss from the single reception point to the user equipment.

At this point, if the single reception point that receives the physical uplink control channel is the serving cell base station of the user equipment, the pathloss from the serving cell base station to the user equipment based on the serving cell reference signal as issued according to the prior art.

If the single reception point that receives the physical uplink control channel is a non-serving cell of the user equipment, a specific reference signal is indicated to the user equipment through a higher layer signaling. The reference signal for example is a cell reference signal (CRS) of a non-serving cell as a single reception point or a channel state information reference signal (CSI-RS). The pathloss from the single reception point to the user equipment is a pathloss measured based on the specific reference signal from the non-serving cell base station to the user equipment. In one embodiment, if the single reception point that receives the uplink control channel is an access point in an uplink sharing channel multi-point coordinate set, an information index of the specific reference signal for measuring and calculating the uplink control channel pathloss may be indicated to the user equipment merely through a higher layer signaling.

In a scenario of multi-point reception of the uplink control channel, in step S103, uplink control channel power control is performed by reducing the uplink control channel transmission power of the user equipment to thereby reduce inter-cell interference incurred by multi-point reception coherence combining gain.

When the uplink control channel is received jointly at multiple reception points, coherence combining gain will be obtained. However, it should be noted the control signal in the physical uplink control channel according to LTE-Advanced Rel-10 3GPP TS36.213 V10.1.0 has a fixed modulation and coding level. Thus, unlike the physical uplink sharing channel, the coherence combining gain from multi-reception-point joint reception cannot be transferred to signal throughput improvement. When jointly multi-point reception of the uplink control channel, it is required to perform uplink control channel power control by reducing the uplink control channel transmission power of the user equipment to thereby reduce inter-cell interference incurred by multi-point-reception coherence combining gain.

For example, according to one exemplary embodiment of the present invention, in the case of multi-point reception of the uplink control channel, the transmission power of the user equipment is reduced by pre-defining computation of an effective pathloss for the multiple reception points. The user equipment computes the pathloss from each reception point to the user equipment based on corresponding reference signals, respectively, and computes the effective pathloss based on the predefined function, wherein the predefined function may be known to both sides of the user equipment and serving cell base station. The predefined function may include, but not limited to: taking the minimum value of corresponding pathlosses from multiple reception points to the user equipment; taking the average value of corresponding pathlosses from multiple reception points to the user equipment; and taking a multiple of the harmonic average of corresponding pathlosses from multiple reception points to the user equipment. Through the predefined function, the effective pathloss for multiple reception points is controlled under a certain level so as to address the inter-cell interference possibly incurred by the coherence combining gain.

According to another exemplary embodiment of the present invention, in a scenario of multi-point reception of the uplink control channel, reduction of the user equipment uplink control channel transmission power may be indicated by extending the uplink control channel target reception power P₀_{_{—}}_{PUCCh}.

The uplink control channel target reception power P⁰_{_{—}}_{PUCCh} based on the LTE-Advanced Rel-10 3GPP TS36.213 V10.1.0 is composed of a sum of a cell-specific component

$$\text{?}$$

$$\text{?} \text{indicates text missing or illegible when filed}$$

and a user equipment-specific component

$$\text{?}$$

$$\text{?} \text{indicates text missing or illegible when filed}$$

further, the cell-specific component

$$\text{?}$$

$$\text{?} \text{indicates text missing or illegible when filed}$$

and the user equipment-specific component

$$\text{?}$$

$$\text{?} \text{indicates text missing or illegible when filed}$$

are provided through a higher layer signaling.

Thus, in one embodiment, extending the control channel target reception power P₀_{_{—}}_{PUCCh} comprises extending the user equipment-specific component

$$\text{?}$$

$$\text{?} \text{indicates text missing or illegible when filed}$$

of the control channel target reception power.

In one implementation, extending the control channel target reception power P_{0 PUCCh} comprises extending the cell-specific component

$$\text{?}$$

$$\text{?} \text{indicates text missing or illegible when filed}$$

of the control channel target reception power.

For example, a macro-eNB or a network side RRH base station may for example computer the required signal-to-interference plus noise ratio (SINR) or signal-to-interference ratio (SIR) to determine the reduction amount of the uplink control channel transmission power which should be reduced by the user equipment so as to reduce the inter-cell interference incurred by multi-point-reception coherence combining gain. In the extended user equipment-specific component

$$\text{?}$$

$$\text{?} \text{indicates text missing or illegible when filed}$$

or extended cell-specific component

$$\text{?}$$

$$\text{?} \text{indicates text missing or illegible when filed}$$

an added bit may be used to indicate the reduction of the uplink control channel transmission power of the user equipment.

According to another embodiment of the present invention, in the case of multi-point reception of the uplink control channel, a fractional compensation factor is configured to the user equipment so as to partially compensate for the pathloss measured according to a reference signal, thereby reducing the transmission power of user equipment.

For example, a macro-eNB or a RRH network side base station may for example computer the required signal-to-interference plus noise ratio (SINR) or signal-to-interference ratio (SIR) to determine the reduction amount of the uplink control channel transmission power which should be reduced by the user equipment. A pathloss fractional compensation factor α_{PUCCH} dedicated for uplink control channel is introduced to indicate the reduction of the uplink control channel transmission power of the user equipment. The pathloss fractional compensation factor α_{PUCCH} is a user equipment-specific parameter and can be provided to the corresponding user equipment through a higher layer signaling. Because the PUCCH transmission power received at multiple reception points has a requirement lower than or equal to the traditional PUCCH power control for its serving cell, the pathloss fractional compensation factor α_{PUCCH} is set to be less than or equal to 1, i.e., α_{PUCCH}≦1.

According to this embodiment, the misalignment issue of the uplink coordination point set and the downlink coordination point set can be solved, because the effective uplink pathloss of PUCCH power control may be measured and computed based on the channel sounding reference signal SRS at the macro-eNB or RRH.

In step S104, the processing flow of this method ends.

The solution for power control of an uplink control channel has been described above in the scenario of single-point reception of the uplink control channel and in the scenario of multi-point reception of the uplink control channel, respectively. Multi-point coordination may be performed in multiple networks and network scenarios, for example, performing multi-point coordination in a homogeneous network, running in a heterogeneous network. In the scenario of heterogeneous network, a scenario exists where a macro base station such as macro-eNB and a low power node such as RRH have a cell identifier, respectively (CoMP3), and a scenario exists where the macro base station such as macro-eNB and the low power node such as RRH share a cell identifier (CoMP4), etc. For these different scenarios, the present invention will provide advice on how to configured the uplink control channel transmission of a multi-point coordination system.

In the multi-point coordination system, the uplink control channel can be received either at a single reception point or at multiple reception points. It may be determined whether to receive the uplink control channel at a single reception point or multiple reception points based on any one or a combination of the following: whether the orthogonal resources available for the uplink control channel in the multi-point coordination system are sufficient; channel quality of the uplink control channel.

In a homogeneous network and in the scenario (CoMP scenario 3) where the macro base station such as macro-eNB and the low power node such as RRH in the heterogeneous network have a cell identifier, respectively, the PUCCH single-point reception loosens the requirement of PUCCH on orthogonal resources. It is because inter-cell interference incurred during PUCCH transmission can be reduced through interference randomization. If the serving cell is selected as a single reception point for receiving PUCCH, the PUCCH power control mechanism based on CRS pathloss measurement as defined in LTE-Advanced Rel-10 3GPP TS36.213 V10.1.0 may be re-used.

In the scenario where the macro base station such as macro-eNB and the low power node such as RRH in the heterogeneous network have a cell identifier (CoMP scenario 3), the downlink serving cell relation is based on the maximum reference signal reception power (RSRP). It has been appreciated that a mismatch between the RSRP border and the optimal uplink pathloss border might exist. The Macro-UE between the borders might generate a strong interference to PUCCH of pico-UE. For example, if the low power node is located at an edge of the macro cell, it may cause very serious inter-cell interference to offset the interference from the Macro-UE by raising the PUCCH transmission power of the pico-UE might. Some literatures have disclosed that an uplink reception point and a downlink transmission point may be set respectively. Thus, considering these factors regarding the uplink control channel quality, in CoMP scenario 3 where PUCCH single point reception is employed, the PUCCH single reception point may be different from the base station of the UE downlink serving cell. In order to solve this problem, a specific reference signal, for example CRS or CSI-RS, etc., for PUCCH pathloss measurement and calculation may be appointed to the user equipment through a higher layer signaling. Besides, if the PUCCH single reception point is a node in a PUSCH multi-point coordination point set, the signal index of a specific reference signal for PUCCH pathloss measurement and calculation may be simply notified to the UE through a higher level signaling.

For the scenario where the macro base station such as macro-eNB and the low power node such as RRH in a heterogeneous network share a cell identifier (CoMP scenario 4), considering the factors that multiple access points share the cell identifier and the orthogonal resources for PUCCH transmission is guaranteed within the coverage of macro cell, the available PUCCH orthogonal resources cannot be released by using the PUCCH single reception point reception. Therefore, in the case of little impact on backhaul delay, it could be beneficial to use multiple reception points to receive PUCCH in CoMP scenario 4 so as to obtain a coherence combining gain.

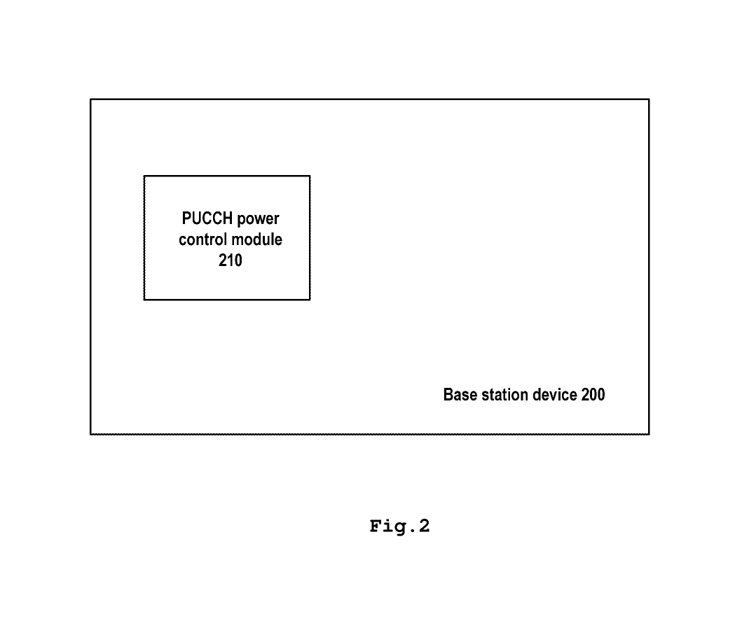

FIG. 2 shows a block diagram of an apparatus implemented in abase station device for power control of a uplink control channel in a multi-point coordination system according to one exemplary embodiment of the present invention.

As shown in FIG. 2, a base station device 200 may be acting as either a serving cell base station device or a non-serving cell base station device, of a user equipment

A power control module 210 for an uplink control channel in a multi-point coordination system according to one exemplary embodiment of the present invention may be implemented in the base station device 200.

The power control module 210 generally operates in according to the physical uplink control channel (PUCCH) power control as defined in 3GPP TS36.213 V10.1.0. According to an exemplary embodiment of the present invention, the power control module 210 is configured to perform uplink control channel power control based on measured pathloss from a single reception point to the user equipment in a scenario of single-point reception of the uplink control channel; and the power control module 210 performs uplink control channel power control by reducing uplink control channel transmission power of the user equipment to thereby reduce inter-cell interference incurred by multi-point reception combining gain in a scenario of multi-point reception of the uplink control channel.

In the scenario of single-point reception of the uplink control channel, if the single reception point that receives the physical uplink control channel acts as the serving cell base station of the user equipment, then the power control module 210 issues a serving cell reference signal according to the prior art. The user equipment measures the pathloss from the serving cell base station to the user equipment based on the serving cell reference signal.

In the scenario of single-point reception of the uplink control channel, if the single reception point that receives the physical uplink control channel is a non-serving cell base station of the user equipment, then the power control module 210 indicates a specific reference signal to the user equipment for example through a higher layer signaling. Particularly, the power control module 210 may merely indicate a signal index of the specific reference signal for uplink control channel pathloss measurement and computation to the user equipment through a higher layer signaling.

In the scenario of multi-point reception of the uplink control channel, the power control module 210 reduces the user equipment power transmission by using a predefined computation of an effective pathloss for the multiple reception points together with the user equipment.

In a scenario of receiving the uplink control channel using the multiple reception points, the power control module 210 may indicate reduction of the user equipment uplink control channel transmission power by using an extended uplink control channel target reception power P₀_{_{—}}_{PUCCh}. Here, the power control module 210 may use the user equipment-specific component

$$\text{?}$$

$$\text{?} \text{indicates text missing or illegible when filed}$$

for extending the control channel target reception power or the cell-specific component

$$\text{?}$$

$$\text{?} \text{indicates text missing or illegible when filed}$$

for extending the control channel target reception power, or a combination of the two.

In the scenario of multi-point reception of the uplink control channel, the power control module 210 may introduce a pathloss fractional compensation factor α_{PUCCH} dedicated for the uplink control channel to indicate the reduction of the user equipment uplink control channel transmission power.

The power control module 210 may issue the pathloss fractional compensation factor α_{PUCCH} to the user equipment through a higher layer signaling. Here, the pathloss fractional compensation factor α_{PUCCH} is less than or equal to 1, i.e., α_{PUCCH}≦1.

It should be noted that FIG. 2 merely illustrates modules/units closely related to the technical solution of the present invention; the wireless access point device and user equipment may further comprise any functional module/unit as required by their own functionalities. These functional modules/units are known to those skilled in the art and thus their depictions are omitted here.

The embodiments of the present invention may be implemented in software, hardware, application logic, or a combination of software, hardware, and application logic. The software, application logic and/or hardware may reside on a base station, access point, or a similar network device. Where necessary, apart of the software, application logic and/or hardware may reside on an access point, while a part of the software, application logic and/or hardware may reside on a network element such as base station. In an exemplary embodiment, the application logic, software or instruction set is maintained on any of various conventional computer-readable mediums. In the context of the present description, the “computer-readable medium” may be any medium or module that can include, store, deliver, propagate or transmit instructions available for an instruction execution system, module or device such as a computer or instructions regarding the instruction execution system, module or device such as a computer. The computer-readable medium may comprise a computer-readable memory medium that can be any medium or module that can include or store instructions available for an instruction execution system, module or device such as a computer or instructions regarding the instruction execution system, module or device such as a computer.

Where necessary, the different functions as disclosed here may be executed in different orders and/or in parallel. Besides, where necessary, one or more of the above functions can be alternative or combined.

Although various aspects of the present invention are illustrated in independent claims, other aspects of the present invention include other combinations of the features from the embodiments and/or dependent claims having features of independent claims, instead of merely including the combinations explicitly illustrated in the claims.

It should also be noted that although the exemplary embodiments of the present invention have been described above, these depictions should not looked upon as limitation. On the contrary, various transformations and modifications are allowed without departing from the scope of the present invention as limited in the appended claims.

1. A method for power control of a uplink control channel in a coordinated multi-point transmission system, comprising:
in a scenario of receiving the uplink control channel at multiple reception points, performing the power control of the uplink control channel by reducing uplink control channel transmission power of the user equipment to thereby reduce inter-cell interference incurred by multi-point reception coherence combining gain wherein the uplink control channel transmission power of the user equipment is reduced by pre-defining computation of an effective pathloss for the multiple reception points.

2.-5. (canceled)

6. The method according to claim 1, wherein:
in a scenario of receiving the uplink control channel at the multiple reception points, the reduction of the uplink control channel transmission power of the user equipment is indicated by extending the uplink control channel target reception power.

7. The method according to claim 6, wherein extending the control channel target reception power comprises extending a user equipment-specific component of the control channel target reception power.

8. The method according to claim 6, wherein extending the control channel target reception power comprises extending a cell-specific component of the control channel target reception power.

9. The method according to claim 1, wherein:
in a scenario of receiving the uplink control channel at the multiple reception points, a fractional compensation factor is configured to the user equipment so as to partially compensate for the pathloss measured according to a designated reference signal, thereby reducing the transmission power of user equipment.

10.-12. (canceled)

13. The method according to claim 1, wherein:
in a heterogeneous network, in a scenario where a macro base station and a low power node share a same cell identifier, the uplink control channel is received by multiple reception points.

14. The method according to claim 1, wherein the uplink control channel is a physical uplink control channel PUCCH.

15. An apparatus for power control of a uplink control channel in a coordinated multi-point transmission system, comprising:
a module configured to, in a scenario of receiving the uplink control channel at multiple reception points, perform the power control of the uplink control channel by reducing uplink control channel transmission power of the user equipment to thereby reduce inter-cell interference incurred by multi-point reception coherence combining gain, wherein the uplink control channel transmission power of the user equipment is reduced by pre-defining computation of an effective pathloss for the multiple reception points.

16.-19. (canceled)

20. The apparatus for power control of a uplink control channel according to claim 15, further comprising:
a module configured to indicate, in a scenario of receiving the uplink control channel at the multiple reception points, reduction of the uplink control channel transmission power of the user equipment through extending the uplink control channel target reception power.

21. The apparatus for power control of a uplink control channel according to claim 20, wherein extending the control channel target reception power comprises extending a user equipment-specific component of the control channel target reception power.

22. The apparatus for power control of a uplink control channel according to claim 19, wherein extending the control channel target reception power comprises extending a cell-specific component of the control channel target reception power.

23. The apparatus for power control of a uplink control channel according to claim 15, further comprising:
a module configured to configure, in a scenario of receiving the uplink control channel at the multiple reception points, a fractional compensation factor to the user equipment so as to partially compensate for the pathloss measured according to a designated reference signal, thereby reducing the transmission power of user equipment.

24.-26. (canceled)

27. The apparatus for power control of a uplink control channel according to claim 15, wherein:
in a heterogeneous network, in a scenario where a macro base station and a low power node share a same cell identifier, the uplink control channel is received by multiple reception points.

28. The apparatus for power control of a uplink control channel according to claim 15, wherein the uplink control channel is a physical uplink control channel PUCCH.

29. A base station device, comprising the apparatus for power control of a uplink control channel according to claim 15.
